(19) United States
(12) Patent Application Publication
(10) Pub. No.: US 2026/0338146 A1
(43) Pub. Date: Oct. 29, 2026

(54) FUEL PUMP SYSTEM FOR A DIESEL ENGINE

(71) Applicant: SPE Motorsport, LLC, Latrobe, PA (US)

(72) Inventor: Daniel Snyder, Latrobe, PA (US)

(73) Assignee: SPE Motorsport, LLC, Latrobe, PA (US)

(21) Appl. No.: 19/653,559

(22) Filed: Apr. 21, 2026

Related U.S. Application Data
(60) Provisional application No. 63/793,810, filed on Apr. 24, 2025.

(51) Int. Cl. F02M 59/12; F02B 67/06

(52) U.S. Cl. CPC F02M 59/12; F02B 67/06

(57) ABSTRACT

A fuel pump system for a diesel engine includes a manifold, a high pressure fuel pump, a plurality of first fluid conduits, a plurality of second fluid conduits, a third fluid conduit, at least one fourth fluid conduit, and an idler. The manifold including a low pressure section fluidly connected to a low pressure fuel source—such as a fuel tank—by the plurality of first fluid conduits, and fluidly connected to the high pressure fuel pump by the plurality of second fluid conduits. The manifold further including a high pressure section fluidly connected to the high pressure fuel pump by third fluid conduit, and fluidly connected an intake manifold of the diesel engine by the at least one fourth fluid conduit. The high pressure fuel pump being mechanically driven by a belt and pulley. The idler being rotationally connected to a vacuum pump by a gear.

### CROSS REFERENCES AND PRIORITIES

This Application claims priority from U.S. Provisional Patent Application No. 63/793,810 filed on 24 Apr. 2025, the teachings of which are incorporated by reference herein in its entirety.

### BACKGROUND

Internal combustion engines for vehicles utilize combustion of a fuel with an oxidizer in a combustion chamber to achieve a controlled explosion. Expansion of high-temperature and high-pressure gases produced by the controlled explosion cause reciprocating movement of pistons within a piston cylinder. These pistons are commonly connected to a crankshaft by connecting rods which transfers the reciprocating motion of the pistons to rotational motion in the crankshaft. The rotational motion can then be connected to the vehicle's drivetrain to cause rotational motion which propels the vehicle's wheels.

Diesel engines are a specific type of internal combustion engine which utilize elevated temperature of air in the cylinders due to mechanical compression to initiate the controlled explosion. Like most internal combustion engines vehicles, fuel for a diesel engine equipped vehicle originates from a fuel tank mounted in the vehicle and is transferred into the combustion chamber by a fuel pump.

One common fuel pump utilized in many modern diesel engines is referred to as a CP4 fuel pump. In many applications the CP4 fuel pump will be located in the diesel engine's valley and connected to the diesel engine's camshaft via a gear. Rotation of the cam shaft causes the CP4 fuel pump to rotate thereby increasing pressure of fuel flowing into and through the CP4 fuel pump for discharge and distribution into the combustion chamber.

In practice, CP4 fuel pumps—particularly those located in the valley of a diesel engine and connected to the diesel engine by a camshaft via a gear—have proven unreliable and prone to failures. These failures can often result in metal shaving contaminants in the diesel engine's fuel system and are believed to be caused by a number of factors including the effects of using ultra-low sulfur diesel (ULSD) fuel which may lack sufficient lubricity for certain components of the CP4 fuel pump.

CP3 diesel fuel pumps have been considered as an alternative to CP4 fuel pumps. CP3 diesel fuel pumps have shown improved resistance to failure, even when utilizing ULSD diesel fuel. However, the structure of a CP3 fuel pump does not permit location of the fuel pump in the valley of the diesel engine or connection to the diesel engine's camshaft via a gear. Accordingly, modifying diesel engine fuel pump systems—such as those found in a 6.7 L Powerstroke® engine available from Ford Motor Company of Dearborn, Michigan, U.S.A.—to utilize a CP3 fuel pump instead of a CP4 fuel pump has proven problematic. These problems may be exacerbated when the stock CP4 fuel pump is rotationally connected to drive other components of the vehicle such as a vacuum pump utilized for a brake booster.

The need exists, therefore, for an improved fuel pump system for a diesel engine which permits use of a CP3 diesel fuel pump while maintaining the functionality of other components such as a vacuum pump utilized for a brake booster.

### SUMMARY

Described herein is a fuel pump system for a diesel engine. The fuel pump system includes a manifold, a high pressure fuel pump, a plurality of first fluid conduits, a plurality of second fluid conduits, a third fluid conduit, at least one fourth fluid conduit, and an idler rotationally connected to a vacuum pump by a gear. The manifold including a lower pressure section and a high pressure section. The low pressure section including a plurality of low pressure intake ports fluidly connected to a low pressure chamber which is fluidly connected to a plurality of low pressure outlet ports. The high pressure section including a high pressure intake port fluidly connected to a high pressure chamber which is fluidly connected to at least one high pressure outlet port. The high pressure fuel pump being mechanically driven by a belt and a pulley, and including a plurality of fuel pump intake ports and a plurality of fuel pump outlet ports. Each first fluid conduit being fluidly connected between a low pressure fuel source and a low pressure intake port of the plurality of low pressure intake ports. Each second fluid conduit being fluidly connected between a low pressure outlet port of the plurality of low pressure outlet ports and a fuel pump intake port of the plurality of fuel pump intake ports. The third fluid conduit being fluidly connected between the fuel pump outlet port and the high pressure intake port. Each fourth fluid conduit being connected between the at least one high pressure outlet port and an intake manifold of the diesel engine.

In some embodiments, the plurality of low pressure intake ports may include two low pressure intake ports. In such embodiments, the plurality of first fluid conduits may include two first fluid conduits.

In certain embodiments, the plurality of low pressure outlet ports may include two low pressure outlet ports. In such embodiments, the plurality of fuel pump intake ports may include two fuel pump intake ports, and the plurality of second fluid conduits may include two second fluid conduits.

In some embodiments, the belt may be a serpentine belt connected to a crankshaft of the diesel engine. In certain embodiments, the gear may be driven by a camshaft of the diesel engine.

### BRIEF DESCRIPTION OF FIGURES

FIG. 1 illustrates a block diagram with fuel flow path of an exemplary embodiment of a fuel pump system for a diesel engine.

FIG. 2 illustrates an exploded perspective view of an exemplary embodiment of a fuel pump system for a diesel engine.

FIG. 3 illustrates an assembled perspective view of an exemplary embodiment of a fuel pump system for a diesel engine.

FIG. 4 illustrates an exploded perspective view of an exemplary embodiment of a fuel pump system with a diesel engine.

FIG. 5 illustrates an perspective view of an exemplary embodiment of a fuel pump system connected to a diesel engine.

### DETAILED DESCRIPTION

Disclosed herein is fuel pump system for a diesel engine. As described herein, the following numbers refer to the following structures as noted in the Figures.
5 refers to a diesel engine.
10 refers to a fuel pump system.
20 refers to an intake manifold.
50 refers to a low pressure fuel source.

1100 refers to a manifold.
110 refers to a low pressure section.
111 refers to a low pressure intake port.
112 refers to a low pressure outlet port.
120 refers to a high pressure section.
121 refers to a high pressure intake port.
122 refers to a high pressure outlet port.
200 refers to a high pressure fuel pump.
210 refers to a belt.
220 refers to a pulley.
230 refers to a fuel pump intake port.
240 refers to a fuel pump outlet port.
300 refers to a first fluid conduit.
400 refers to a second fluid conduit.
500 refers to a third fluid conduit.
600 refers to a fourth fluid conduit.
700 refers to an idler.
800 refers to a vacuum pump.

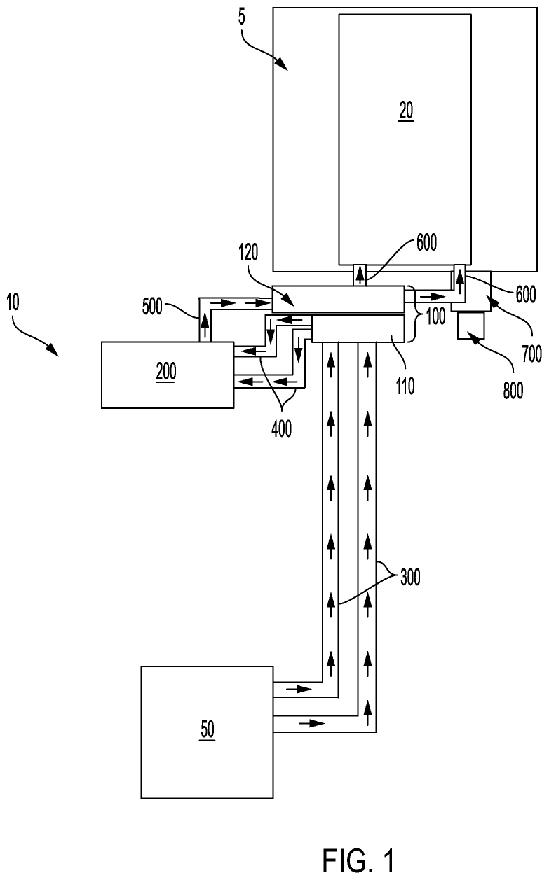

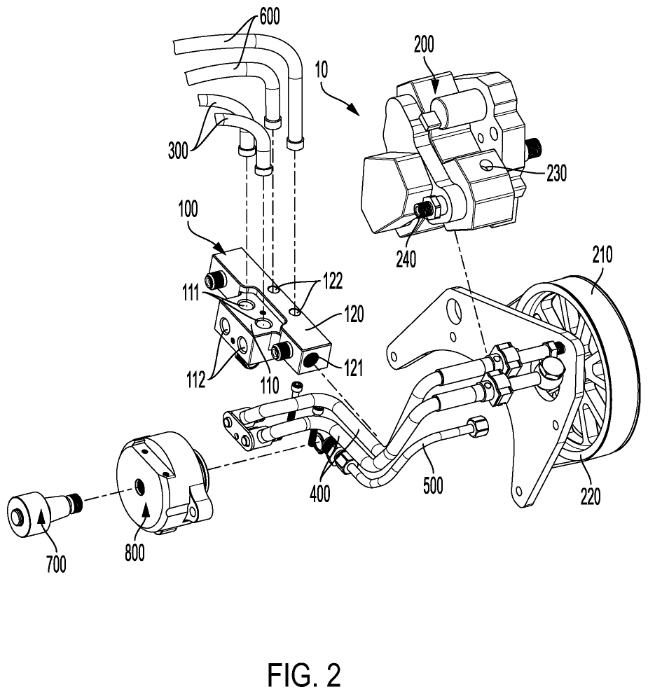

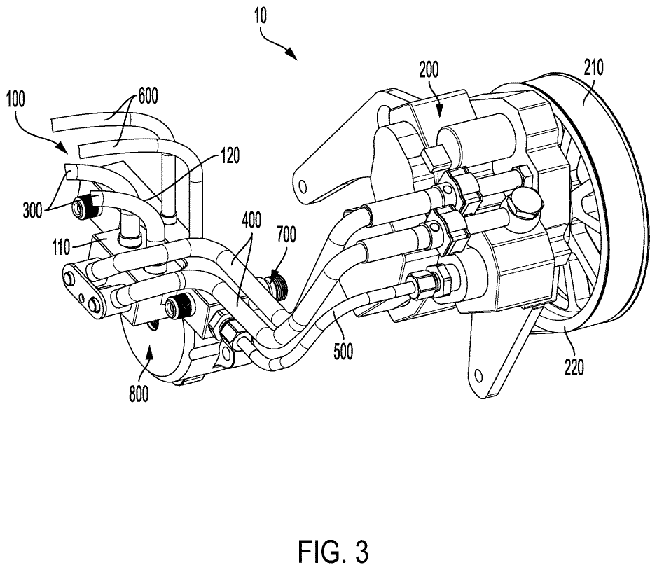

FIG. 1 illustrates a block diagram of an exemplary embodiment of a fuel pump system (10) for a diesel engine (5) with FIG. 2 and FIG. 3 showing exploded and assembled views respectively of such an exemplary embodiment. As shown in FIG. 1, the fuel pump system includes a manifold (100), a high pressure fuel pump (200), a plurality of first fluid conduits (300), a plurality of second fluid conduits (400), a third fluid conduit (500), at least one fourth fluid conduit (600), an idler (700), and a vacuum pump (800).

Each first fluid conduit (300) of the plurality of first fluid conduits may be fluidly connected between a low pressure fuel source (50) in the vehicle and a low pressure intake port (111) in the manifold (100). Typically, the low pressure fuel source will be in the form of a fuel tank mounted within the vehicle. Within the fuel tank may be a lift pump that that discharges fuel at low pressure out of the fuel tank and into the first fluid conduits. The low pressure fuel source being configured to provide fuel flow at low pressures—typically in the range of between 60 and 75 psi—from the low pressure fuel source to the manifold via the first fluid conduits. Exemplary embodiments of a first fluid conduit include a flexible hose, a rigid tube, and the like. Preferably, the first fluid conduit(s) will include fittings at opposing ends thereof allowing the first fluid conduit(s) to removably connect to fittings extending from the low pressure fuel source and the low pressure intake port(s) of the manifold respectively.

Each second fluid conduit (400) of the plurality of second fluid conduits may be fluidly connected between a low pressure outlet port (112) in the manifold (100) and a fuel pump intake port (230) of the high pressure fuel pump (200). The manifold allowing the low pressure fuel from the low pressure fuel source to flow through and out of the manifold and into the high pressure fuel pump. Exemplary embodiments of a second fluid conduit include a flexible hose, a rigid tube, and the like. Preferably, the second fluid conduit(s) will include fittings at opposing ends thereof allowing the second fluid conduit(s) to removably connect to fittings extending from the low pressure outlet port(s) and the fuel pump intake port(s) respectively.

The third fluid conduit (500) may be fluidly connected between a fuel pump outlet port (240) of the high pressure fuel pump (200) and a high pressure intake port (121) of the manifold (100). The manifold allows fuel flow at high pressures—typically in the range of between 2,500 and 35,000 psi—from the high pressure fuel pump through the manifold for distribution to an intake manifold (20) of the diesel engine via fourth fluid conduit(s) (600) as described herein. Exemplary embodiments of a third fluid conduit include a flexible hose, a rigid tube, and the like. Preferably, the third fluid conduit will include fittings at opposing ends thereof allowing the third fluid conduit to removably connect to fittings extending from the fuel pump outlet port and the high pressure intake port respectively.

Each fourth fluid conduit (600) may be fluidly connected between a high pressure outlet port (122) of the manifold (100) and an intake manifold (20) of the diesel engine. In some embodiments, the intake manifold may include one or more fuel rails for delivering pressurized diesel fuel to the intake manifold for distribution into the diesel engine's combustion chambers. In such embodiments, the fourth fluid conduit(s) may be connected between the high pressure outlet port(s) and the fuel rails. The manifold allows fuel flow at high pressure—typically in the range of between 2,500 and 35,000 psi—from the high pressure fuel pump through the manifold to be distributed to the intake manifold (20) of the diesel engine via fourth fluid conduit(s). Exemplary embodiments of a fourth fluid conduit include a flexible hose, a rigid tube, and the like. Preferably, the fourth fluid conduit(s) will include fittings at opposing ends thereof allowing the fourth fluid conduit(s) to removably connect to fittings extending from the high pressure outlet port(s) and the intake manifold/fuel rail(s) respectively.

The manifold (100) may be formed as two separate sections—or chambers—which may be integrated into a single housing or may be formed in separate housings. An example of such a manifold is illustrated in FIGS. 2 and 3. The separate sections of the manifold may include a low pressure section (110) and a high pressure section (120). The low pressure section includes a plurality of low pressure intake ports (111) located on a surface of the low pressure section, a low pressure chamber located on the inside of the low pressure section, and a plurality of low pressure outlet ports (112) located on a surface of the low pressure section. The plurality of low pressure intake ports and the plurality of low pressure outlet ports are each fluidly connected to the low pressure chamber via the interior of the low pressure section. The low pressure section receiving fuel flow from the low pressure fuel source ((50) as shown in FIG. 1) via the plurality of first fluid conduits (300) and passing the fuel flow into the high pressure fuel pump (200) via the plurality of second fluid conduits (400) as described herein. The high pressure section includes a high pressure intake port (121) located on a surface of the high pressure section, a high pressure chamber located on the inside of the high pressure section, and at least one high pressure outlet port (122) located on a surface of the high pressure section. The plurality of high pressure intake ports and the plurality of high pressure outlet ports are each fluidly connected to the high pressure chamber via the interior of the high pressure section. The high pressure section receiving fuel flow from the high pressure fuel pump via the third fluid conduit (500) and passing the fuel flow into the intake manifold ((20) as shown in FIG. 1) of the diesel engine ((5) as shown in FIG. 1) via the at least one fourth fluid conduit (600) as described herein.

The number and orientation of first fluid conduits, second fluid conduits, third fluid conduits, and fourth fluid conduits may take many forms. While FIGS. 1 and 2 illustrate two separate first fluid conduits, two separate second fluid conduits, a single third fluid conduit, and a single fourth fluid conduit, other embodiments may exist. In general, the number of first fluid conduits and second fluid conduits may be an integer in a range selected from the group consisting of between 2 and 8, between 2 and 6, between 2 and 4, between 4 and 8, between 4 and 6, or between 6 and 8. The number of third fluid conduits and fourth fluid conduits may be an integer in a range selected from the group consisting of between 1 and 8, between 1 and 6, between 1 and 4, between 2 and 8, between 2 and 6, between 2 and 4, between 4 and 8, between 4 and 6, or between 6 and 8.

FIGS. 2 and 3 further illustrate an exemplary embodiment of an idler (700) and a vacuum pump (800) for the fuel pump system (10). An idler refers to a mechanical gear which provides support and alignment for other moving parts—such as the vacuum pump. The vacuum pump may create a vacuum used for various functions such as brake boosters and pneumatic systems, and may be connected to the idler by a gear. In embodiments where the fuel pump system is utilized with a 6.7 liter Powerstroke® diesel engine available from Ford Motor Company of Dearborn, Michigan, U.S.A., the idler may connect to the engine valley via a gear connection to the engine's camshaft as used in factory applications to drive a factory fuel pump which is replaced in embodiments of the invented fuel pump system by the high pressure fuel pump (200). While factory applications would include a rotational connection between the factory fuel pump and the factory vacuum pump, embodiments of the invented fuel pump system allow an operator to utilize improved high pressure fuel pumps driven by the belt (210) and pulley (220) described herein while driving the vacuum pump via the idler so as not to lose the functionality of the vacuum pump.

FIGS. 2 and 3 further illustrate the belt (210) and pulley (220) used to mechanically drive the high pressure fuel pump (200) in exemplary embodiments of the fuel pump system (10). The belt may be in the form of a typical rubber belt having engagement members configured to interact with corresponding engagement members on the pulley such that-when a rotational force is applied to the belt by another component of the diesel engine-the rotational force transfers to the pulley. The pulley being rotationally connected to a shaft extending from the high pressure fuel pump such that rotation of the pulley operationally drives the high pressure fuel pump.

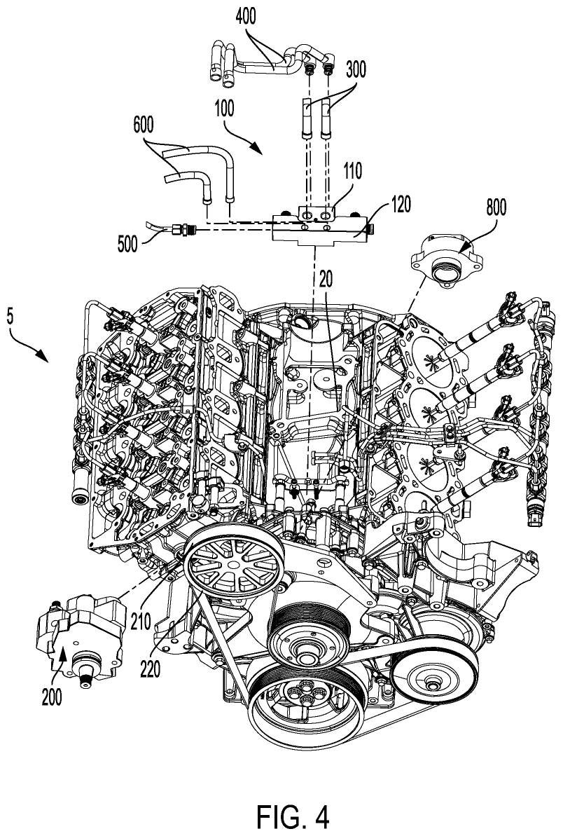

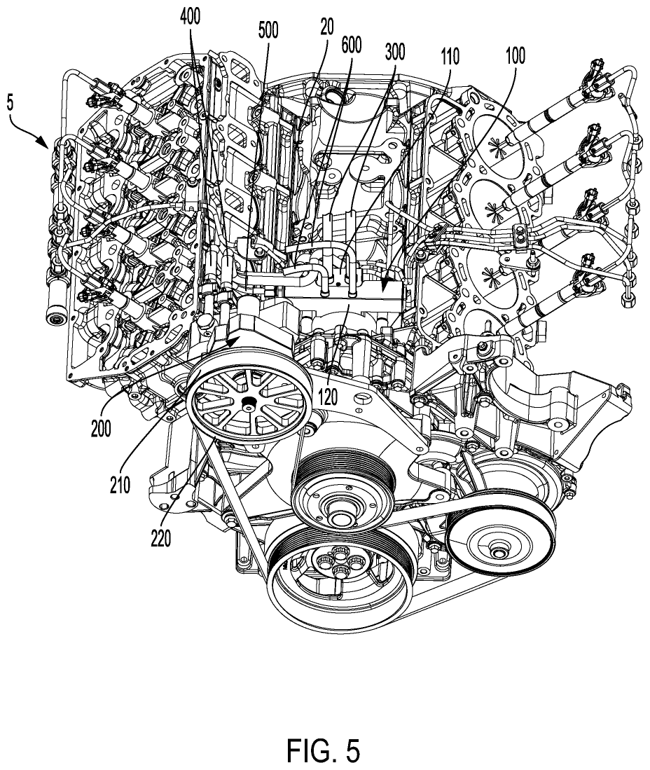

In some embodiments, the other component of the diesel engine (5) which applies rotational force to the belt (210) may be a crankshaft or camshaft while the belt may be in the form of a serpentine belt. One such exemplary embodiment is illustrated in FIGS. 4 and 5 with FIG. 4 illustrating the fuel pump system (10) exploded from the diesel engine (5) and FIG. 5 illustrating the fuel pump system connected to the diesel engine.

Embodiments of the fuel pump system (10) described herein allows for use of a single CP3 fuel pump as the high pressure fuel pump (200) with the fuel pump driven by the belt (210) and pulley (220) instead of utilizing a less reliable CP4 fuel pump located in the engine's valley and driven by a camshaft connected to the fuel pump by a gear. In addition, the fuel pump system embodiments described herein maintain functionality of other components—such as a vacuum pump utilized for a brake booster or other pneumatic components—by way of the idler located in the engine's valley and driven by the camshaft in the manner of the stock CP4 fuel pump.

While the fuel pump system for a diesel engine has been described as having exemplary designs, the present invention may be further modified within the spirit and scope of this disclosure. This application is therefore intended to cover any variations, uses, or adaptations of the fuel pump system using its general principles.

What is claimed is:

1. A fuel pump system (10) for a diesel engine (5), said fuel pump system comprising:
a manifold (100) comprising:
a low pressure section (110) comprising a plurality of low pressure intake ports (111) fluidly connected to a low pressure chamber which is fluidly connected to a plurality of low pressure outlet port (112); and
a high pressure section (120) comprising a high pressure intake port (121) fluidly connected to a high pressure chamber which is fluidly connected to at least one high pressure outlet ports (122);
a high pressure fuel pump (200) mechanically driven by a belt (210) and a pulley (220), said high pressure fuel pump comprising:
a plurality of fuel pump intake ports (230); and
a fuel pump outlet port (240);
a plurality of first fluid conduits (300) wherein each first fluid conduit is fluidly connected between a low pressure fuel source (50) and a low pressure intake port of the plurality of low pressure intake ports;
a plurality of second fluid conduits (400) wherein each second fluid conduit is fluidly connected between a low pressure outlet port of the plurality of low pressure outlet ports and a fuel pump intake port of the plurality of fuel pump intake ports;
a third fluid conduit (500) fluidly connected between the fuel pump outlet port and the high pressure intake port;
at least one fourth fluid conduit (600) connected between the at least one high pressure outlet port and an intake manifold (20) of the diesel engine;
an idler (700) rotationally connected to a vacuum pump (800) by a gear.

2. The fuel pump system of claim 1, wherein the plurality of low pressure intake ports includes two low pressure intake ports, and the plurality of first fluid conduits includes two first fluid conduits.

3. The fuel pump system of claim 1, wherein the plurality of low pressure outlet ports includes two low pressure outlet ports, the plurality of fuel pump intake ports includes two fuel pump intake ports, and the plurality of second fluid conduits includes two second fluid conduits.

4. The fuel pump system of claim 2, wherein the plurality of low pressure outlet ports includes two low pressure outlet ports, the plurality of fuel pump intake ports includes two fuel pump intake ports, and the plurality of second fluid conduits includes two second fluid conduits.

5. The fuel pump system of claim 1, wherein the belt is a serpentine belt connected to a crankshaft of the diesel engine.

6. The fuel pump system of claim 2, wherein the belt is a serpentine belt connected to a crankshaft of the diesel engine.

7. The fuel pump system of claim 3, wherein the belt is a serpentine belt connected to a crankshaft of the diesel engine.

8. The fuel pump system of claim 4, wherein the belt is a serpentine belt connected to a crankshaft of the diesel engine.

9. The fuel pump system of claim 1, wherein the gear is driven by a camshaft of the diesel engine.

10. The fuel pump system of claim 2, wherein the gear is driven by a camshaft of the diesel engine.

11. The fuel pump system of claim 3, wherein the gear is driven by a camshaft of the diesel engine.

12. The fuel pump system of claim 4, wherein the gear is driven by a camshaft of the diesel engine.

13. The fuel pump system of claim 5, wherein the gear is driven by a camshaft of the diesel engine.

14. The fuel pump system of claim 6, wherein the gear is driven by a camshaft of the diesel engine.

15. The fuel pump system of claim 7, wherein the gear is driven by a camshaft of the diesel engine.

16. The fuel pump system of claim 8, wherein the gear is driven by a camshaft of the diesel engine.
